(19) United States
(12) Patent Application Publication
(10) Pub. No.: US 2013/0175416 A1
(43) Pub. Date: Jul. 11, 2013

(54) CONNECTOR MOUNTING APPARATUS

(71) Applicants: Zhi-Ming ZHU, Wuhan City (CN); Ting WANG, Wuhan City (CN)

(72) Inventors: Zhi-Ming ZHU, Wuhan City (CN); Ting WANG, Wuhan City (CN)

(21) Appl. No.: 13/650,287

(22) Filed: Oct. 12, 2012

(30) Foreign Application Priority Data
Jan. 6, 2012 (CN) 201210003036.6

(51) Int. Cl. F16M 13/02

(52) U.S. Cl. 248/201

(57) ABSTRACT

A connector mounting apparatus includes a mounting bracket and a securing bracket. The mounting bracket receives a connector. The mounting bracket includes two recess portions. The securing bracket includes a front wall and two side walls extending from the front wall. The front wall defines a through hole corresponding to the connector. Each side wall includes a side wall body, a resilient tab extending inward from the side wall body, and a securing tab extending inward from the side wall body. The two securing tabs grasp the two recess portions. The two resilient tabs resist resiliently the connector.

### BACKGROUND

1. Technical Field

The disclosure generally relates to connector mounting apparatus, especially, to a connector mounting apparatus with electro magnetic interference (EMI) shielding clips.

2. Description of Related Art

Electronic components with USB interfaces are normally encased within a covered metal enclosure. Despite providing an “outer skin” for the computer, the covers are unshielded. The encased electronic components are prone to leak electromagnetic pollution through the covers. Such electromagnetic pollution can interfere with other electronic components outside the enclosure. Thus, shielding components with electromagnetic conductive material is necessary.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector mounting apparatus.

FIG. 2 is similar to FIG. 1, but viewed from another aspect.

FIG. 3 is a view of an assembled connector mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

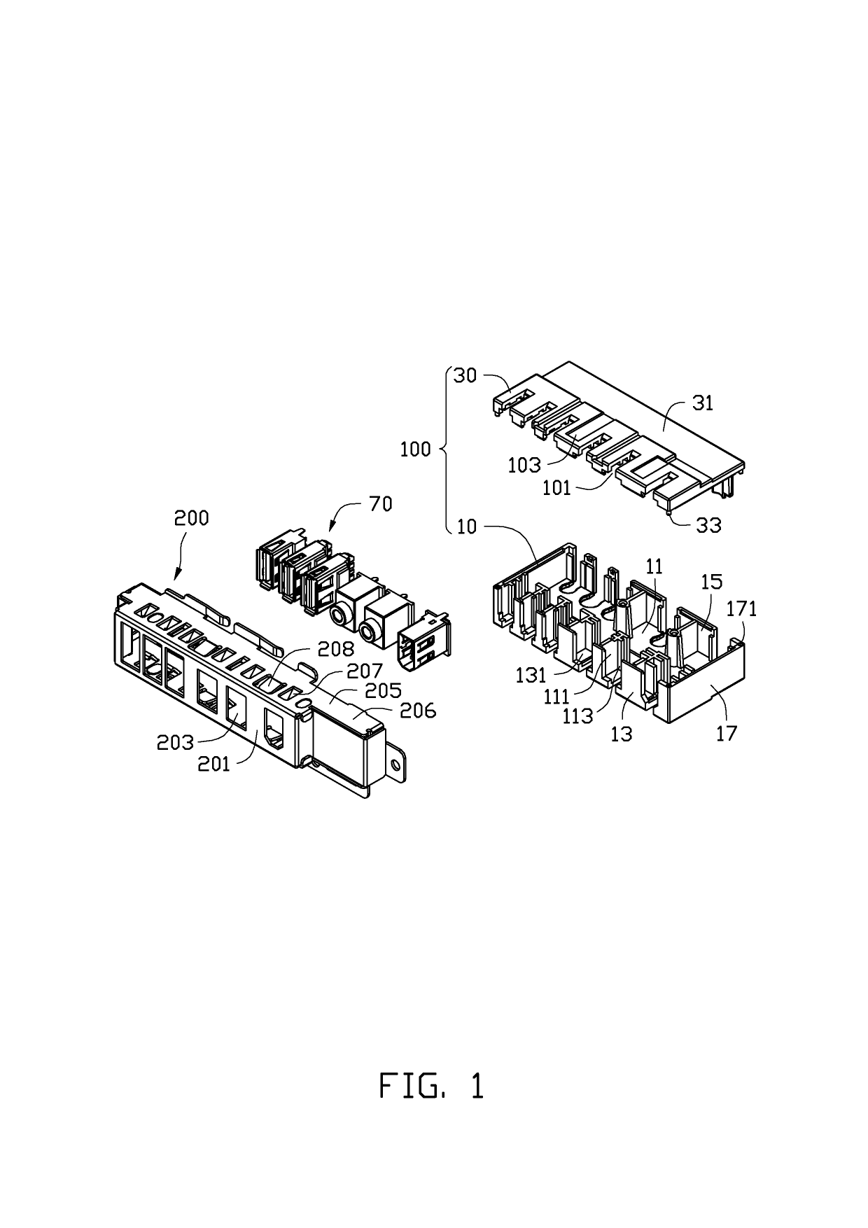

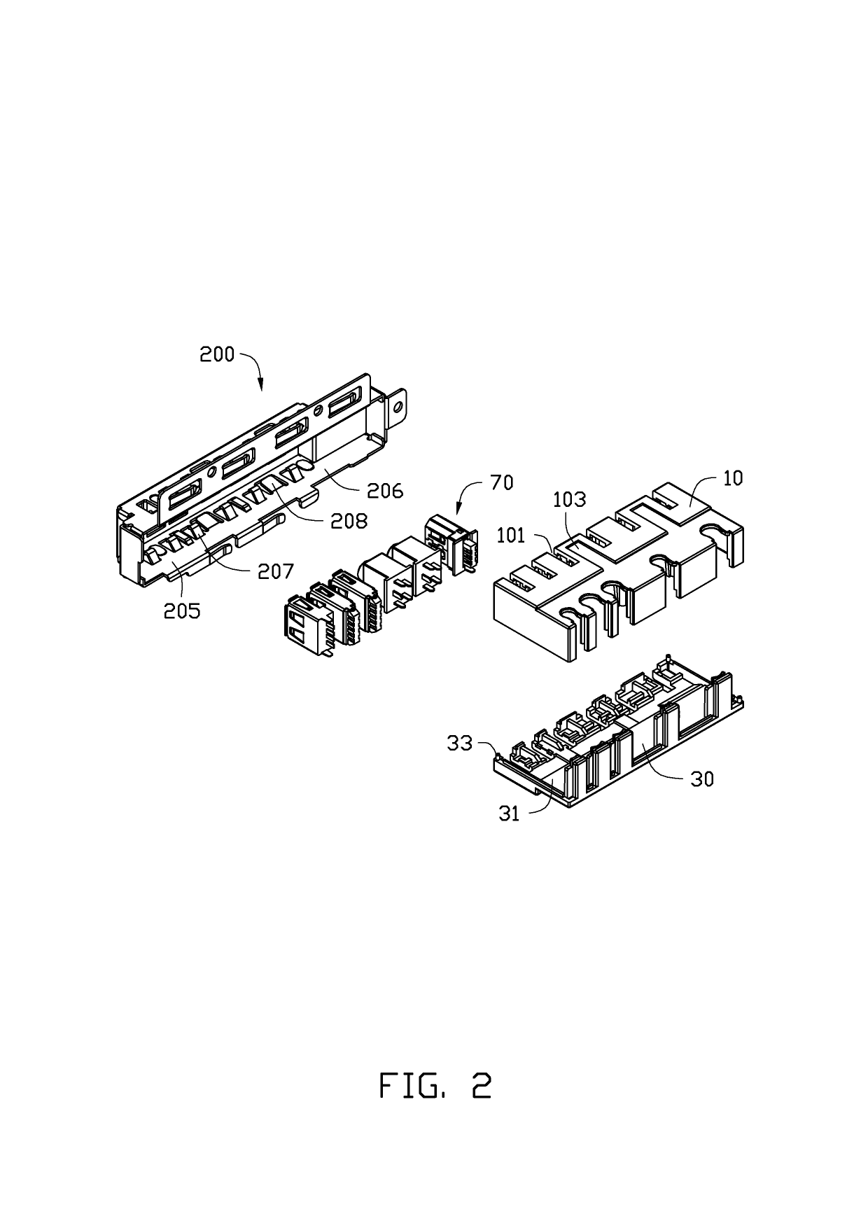

Referring to FIGS. 1 and 2, one embodiment of a connector mounting apparatus is shown. The connector mounting apparatus includes a mounting bracket 100 and a securing bracket 200. The mounting bracket 100 is used for mounting a plurality of connectors 70. The mounting bracket 100 includes a receiving member 10 and a securing member 30. In one embodiment, the plurality of connectors 70 includes USB connectors and audio connectors.

The receiving member 10 includes a base panel 11, a front panel 13 perpendicularly extending from the base panel 11, a rear panel 15 perpendicularly extending from the base panel 11, and two side panels 17 perpendicularly extending from the base panel 11. The front panel 13 is substantially parallel to the rear panel 15. The two side panels 17 are substantially parallel to each other and are connected between the rear panel 15 and the front panel 13. The front panel 13 defines a plurality of receiving openings 131. The receiving member 10 further includes a plurality of receiving portions 111, extending from the base panel 11, corresponding to the receiving openings 131. Each receiving portion 111 defines a receiving space 113 communicating with one receiving opening 131. The receiving space 113 is used for receiving one connector 70.

The side panel 17 defines a plurality of positioning holes 171.

The securing member 30 includes a mounting panel 31 substantially parallel to the base panel 11 and a plurality of positioning posts 33 extending from the mounting panel 31. The base panel 11 and the mounting panel 31 both define a plurality of mounting slots 101 and a plurality of recess portions 103.

The securing bracket 200 includes a front wall 201 and two side walls 205 extending from opposite sides of the front wall 201. The front wall 201 defines a plurality of through holes 203 corresponding to the connectors 70. Each side wall 205 includes a side wall body 206, a plurality of resilient tabs 207 extending inward from the side wall body 206, and a plurality of securing tabs 208 extending inward from the side wall body 206. The resilient tabs 207 are used for resiliently resisting the connectors 70. The securing tabs 208 are used for grasping the recess portions 103.

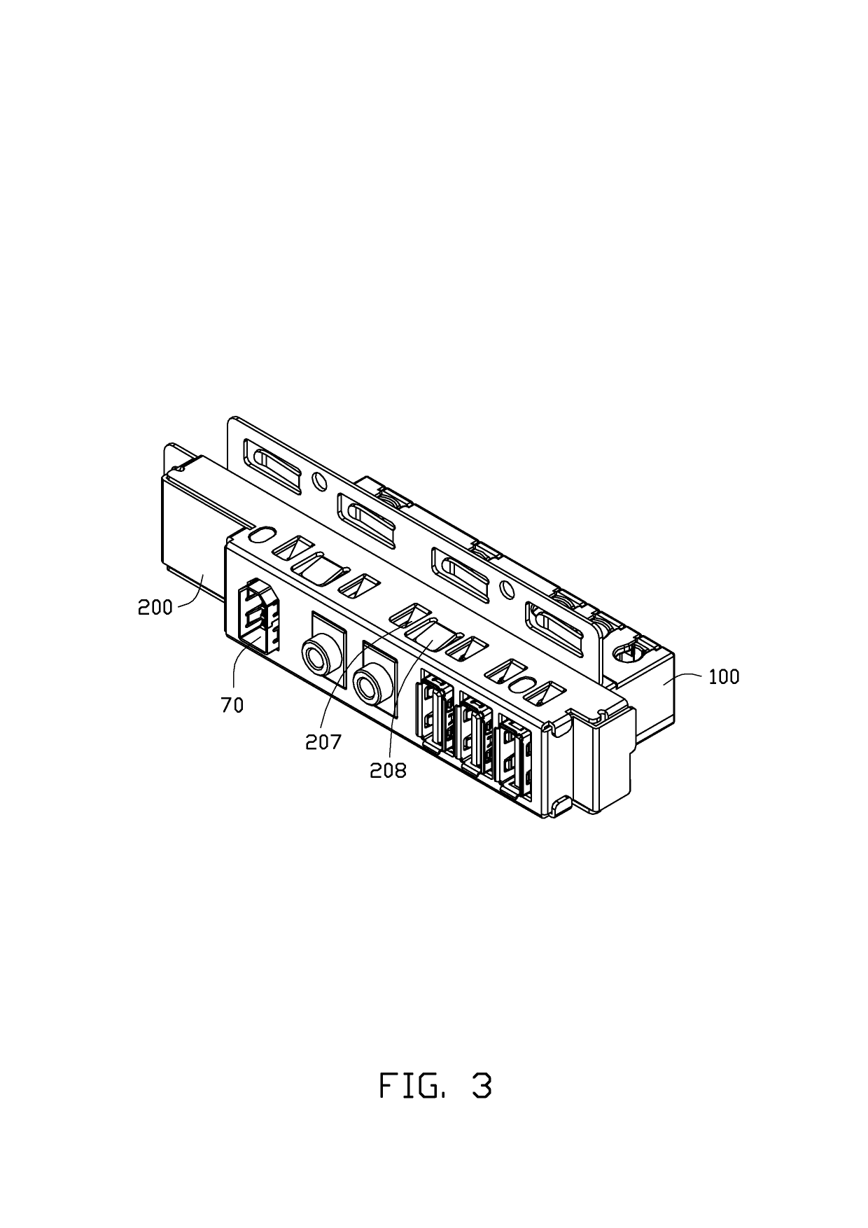

Referring to FIGS. 1 to 3, in assembly, the connectors 70 are placed in the receiving spaces 113 of the receiving member 10. The positioning posts 33 of the securing member 30 are aligned with the positioning holes 171 of the receiving member 10. The securing member 30 moves towards the receiving member 10 to receive the positioning posts 33 in the positioning holes 171. The mounting slots 101 communicate with the receiving openings 131. The connectors 70 are exposed out of the securing member 30 via the mounting slots 101. The through holes 203 of the securing bracket 200 are aligned with the connectors 70. The securing bracket 200 moves towards the mounting bracket 100. The securing tabs 208 of the securing bracket 200 resist the base panel 11 in a way to be deformed. The mounting bracket 100 continues to move to enable the securing tabs 208 to be aligned with the recess portions 103. The securing tabs 208 rebound to grasp the recess portion 103. At this time, the resilient tabs 207 are located in the mounting slots 101 to resist resiliently the connectors 70, thereby providing EMI shielding.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A connector mounting apparatus, comprising:
a mounting bracket, the mounting bracket is configured to receive a connector; the mounting bracket comprises two recess portions; and
a securing bracket, the securing bracket comprises a front wall and two side walls extending from the front wall; the front wall defines a through hole corresponding to the connector; each of the two side walls comprises a side wall body, a resilient tab extending inward from the side wall body, and a securing tab extending inward from the side wall body; the two securing tabs grasp the two recess portions; and the two resilient tabs are configured to resiliently resist the connector.

2. The connector mounting apparatus of claim 1, wherein the mounting bracket further comprises a receiving member and a securing member; the receiving member comprises a base panel and two side panels extending from the base panel; each of the two side panels defines a positioning hole; the securing member comprises a mounting panel and two positioning posts, extending from the mounting panel; the two positioning posts are received in the two positioning holes, to enable the connector to be located between the base panel and the mounting panel.

3. The connector mounting apparatus of claim 2, wherein the receiving member further comprises a front panel extending from the base panel; the front panel is substantially perpendicular to the base panel; and the front panel defines a receiving opening corresponding to the through hole.

4. The connector mounting apparatus of claim 3, wherein the receiving member further comprises a receiving portion extending from the base panel; the receiving portion defines a receiving space communicating with the receiving opening; and the receiving space is configured to receive the connector.

5. The connector mounting apparatus of claim 3, wherein the receiving member further comprises a rear panel extending from the base panel, and the rear panel is substantially parallel to the front panel.

6. The connector mounting apparatus of claim 2, wherein the base panel is substantially parallel to the mounting panel.

7. The connector mounting apparatus of claim 2, wherein the two recess portions are defined in the base panel and the mounting panel respectively.

8. The connector mounting apparatus of claim 1, wherein the mounting bracket defines two mounting slots, and the two resilient tabs are configured to resist the connector via the two mounting slots.

9. A connector mounting apparatus, comprising:
a mounting bracket, the mounting bracket comprises a receiving member and a securing member; the receiving member comprises a base panel and a receiving portion extending from the base panel; the securing member comprises a mounting panel; the securing member is mounted to the receiving member to enable a connector to be located between the base panel and the mounting panel; and
a securing bracket, the securing bracket comprises a front wall and two side walls extending from the front wall; each of the two side walls comprises a side wall body and a resilient tab extending inward from the side wall body; and the two resilient tabs are configured to resiliently resist the connector.

10. The connector mounting apparatus of claim 9, wherein the receiving member further comprises two side panels extending from the base panel; each side panel defines a positioning hole; the securing member further comprises two positioning posts extending from the mounting panel; the two positioning posts are received in the two positioning holes.

11. The connector mounting apparatus of claim 10, wherein the front wall defines a through hole corresponding to the connector; the receiving member further comprises a front panel extending from the base panel; the front panel is substantially perpendicular to the base panel; and the front panel defines a receiving opening corresponding to the through hole.

12. The connector mounting apparatus of claim 11, wherein the receiving portion defines a receiving space communicating with the receiving opening; and the receiving space is configured to receive the connector.

13. The connector mounting apparatus of claim 11, wherein the receiving member further comprises a rear panel extending from the base panel, and the rear panel is substantially parallel to the front panel.

14. The connector mounting apparatus of claim 9, wherein the base panel is substantially parallel to the mounting panel.

15. The connector mounting apparatus of claim 9, wherein the mounting bracket comprises two recess portions; each side wall further comprises a securing tab extending inward from the side wall body; and the two securing tabs grasp the two recess portions.

16. The connector mounting apparatus of claim 15, wherein the two recess portions are defined in the base panel and the mounting panel respectively.

17. The connector mounting apparatus of claim 9, wherein the mounting bracket defines two mounting slots to expose the connector, and the two resilient tabs are configured to resist the connector via the two mounting slots.
